(19) United States
(12) Patent Application Publication
(10) Pub. No.: US 2018/0316213 A1
(43) Pub. Date: Nov. 1, 2018

(54) SYSTEMS AND METHODS FOR INTEGRATING POWER SUPPLY FOR CINEMA SEATS WITH BATTERY BACKUP

(71) Applicant: Theatre FX, LLC, Murray, UT (US)

(72) Inventors: David J. Havell, Salt Lake City, UT (US); Ken Barton, Sandy, UT (US); Aaron Best, Murray, UT (US); Tim Hayford, Salt Lake City, UT (US)

(21) Appl. No.: 15/924,008

(22) Filed: Mar. 16, 2018

Related U.S. Application Data
(60) Provisional application No. 62/477,975, filed on Mar. 28, 2017.

(51) Int. Cl. H02J 9/06; A47C 1/124; A47C 1/034; A47C 1/022; A63J 25/00

(52) U.S. Cl. CPC H02J 9/06; A47C 1/124; A63J 25/00; A47C 1/022; A47C 1/0342

(57) ABSTRACT

Embodiments of this invention relate to theater seating, and more particularly to electrically powered reclining theater seating comprising an integrated power supply for providing power to several theater seats, while providing a battery backup system. In some embodiments the integrated power supply unit comprises an AC Source, an AC/DC conversion unit, batteries, a processing and reverse polarity protection unit, an output switching circuit, DC power supply with a battery backup, and connectors for providing DC current to a plurality of theater seats, which can be used as the power source for powered recliners.

### CROSS-REFERENCE TO RELATED APPLICATIONS

This application claim priority benefit to U.S. Provisional Patent Application No. 62/477,975 which was filed Mar. 28, 2017.

### BACKGROUND

### 1. Field of the Invention

This invention relates to theater seating, and more particularly to reclining theater seating comprising an integrated power supply for providing power to several cinema seats while providing a battery backup system.

### 2. Related Art

Theater seats in homes and at cinemas have begun to be installed utilizing electrically powered recliner seats. Such seats are normally dependent on the seat being able to be returned to the home position for the user to be able to easily get out of the seat. The reclined seat may have a back recline feature and/or a seat extension feature. These powered seat features are normally powered using an AC (wall outlet) to DC power supply. If the primary service AC power (wall outlet) goes out, the seat would not continue to function if the power supply did not have a battery backup, and the seated persons would not be able to move the powered seat to a home position or closed position where the person can easily get out of the seat. Additionally, theaters wanting to run more than a single powered recliner seat face the difficulty of providing power to a theater full of electrically powered recliner seats.

### SUMMARY OF THE INVENTION

This invention relates to theater seating, and more particularly to reclining theater seating comprising an integrated power supply for providing power to several cinema seats while providing a battery backup system. In some embodiments the integrated power supply unit comprises an AC Source, an AC/DC conversion unit, batteries, a processing and reverse polarity protection program, an output switching circuit, a DC power supply with a battery backup, and connectors for providing DC current to a plurality of theater seats. The integrated power supply unit can be used as the power source for powered recliners.

In some embodiments of the invention the DC power supply may comprise batteries which continue to provide a power supply for the theater seats to function fully during an AC power interruption. In some embodiments, the battery backup feature will provide power to the seat and will reduce the physical hardship when a person is trying to exit a reclined or a partially reclined seat.

In some embodiments the integrated power supply unit provides features comprising: DC power to multiple seats under normal operating conditions where AC power is present, and DC power to seats under abnormal operating conditions, for example when the AC power is not present.

In some embodiments the integrated power supply unit provides features comprising: physical safety to the person seated since that seated person may be in a reclined positon when AC power is lost, and may not be able to exit the reclined seat.

In some embodiments the integrated power supply unit provides features comprising: multiple recliners are able to be powered and have backup capability. The integrated power unit may be used to provide power to seating in a variety of conditions including seats that are used in homes and in theaters for events such as movies, concerts, gaming and other events which are normally dependent on the seat being able to be returned to the home position for the user to be able to easily get out of the seat.

In some embodiments the batteries and the output of the power supply are in parallel. In some embodiments the external AC power supply will push out as much power as it can, and when it's pushed past its limits the battery backup system may begin to provide DC current to the theater seats.

### BRIEF DESCRIPTION OF THE DRAWINGS

The specific features, aspects and advantages of the present invention will become better understood with regard to the following description and accompanying drawings where:

FIG. 1 shows a perspective view of a representative theater seat on a closed position;

FIG. 2 shows a perspective view of a representative theater seat in an open position;

FIG. 3 shows a perspective view of a series of theater seats in an open position;

FIG. 4 shows a perspective view of the integrated power supply with battery backup unit; and

FIG. 5 shows a schematic block view of a representative integrated power supply with battery backup unit in accordance with some embodiments of the invention.

### DETAILED DESCRIPTION

Embodiments of this invention relate to theater seating, and more particularly to electrically powered reclining theater seating comprising an integrated power supply for providing power to several theater seats, while providing a battery backup system. In some embodiments the integrated power supply unit comprises an AC Source, an AC/DC conversion unit, batteries, a processing and reverse polarity protection program, an output switching circuit, a DC power supply with a battery backup, and connectors for providing DC current to a plurality of theater seats, which can be used as the power source for powered recliners.

In the following description of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

In some embodiments of the invention the DC power supply may comprise batteries which continue to provide a power supply for the theater seats to function fully during an AC power interruption. In some embodiments, the battery backup feature will provide power to the seat and will reduce the physical effort when a person is trying to exit a reclined or a partially reclined seat.

In some embodiments the integrated power supply unit provides features comprising: DC power to multiple seats under normal operating conditions where the AC power is present, and DC power to the seat under abnormal operating conditions, for example when the AC power is not present.

In some embodiments the integrated power supply unit provides physical safety to the person seated since that seated person may be in a reclined positon when AC power is lost, and may not be able to exit the reclined seat.

In some embodiments the integrated power supply unit allows multiple recliners to be powered and have backup capability. The integrated power unit may be used to provide power to seating in a variety of conditions including seats that are used in homes and in theaters for events such as movies, concerts, gaming and other events which are normally dependent on the seat being able to be returned to the home position for the user to be able to easily get out of the seat.

In some embodiments the batteries and the output of the power supply are in parallel. In some embodiments the external AC power supply will push out as much power as it can, and when it's pushed past its limits the battery backup system may begin to provide DC current to the theater seats.

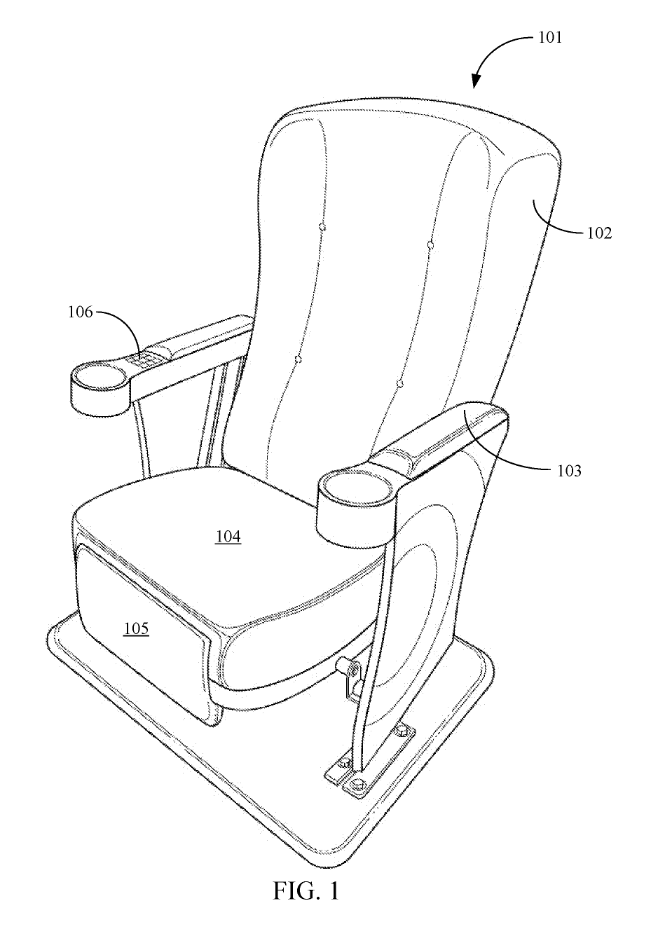

FIG. 1 illustrates a perspective view of a reclining theater seat 101 in a closed position. In some embodiments the theater seat comprises a back rest 102, armrest(s) 103, a seat cushion 104, a leg support 105, a user interface 106, and a power supply (not illustrated). FIG. 1 illustrates theater seat 101 in a closed position, wherein leg support 105 is lowered allowing for individuals utilizing seat 101 to easily sit down in seat cushion 104, or get up from seat cushion 104.

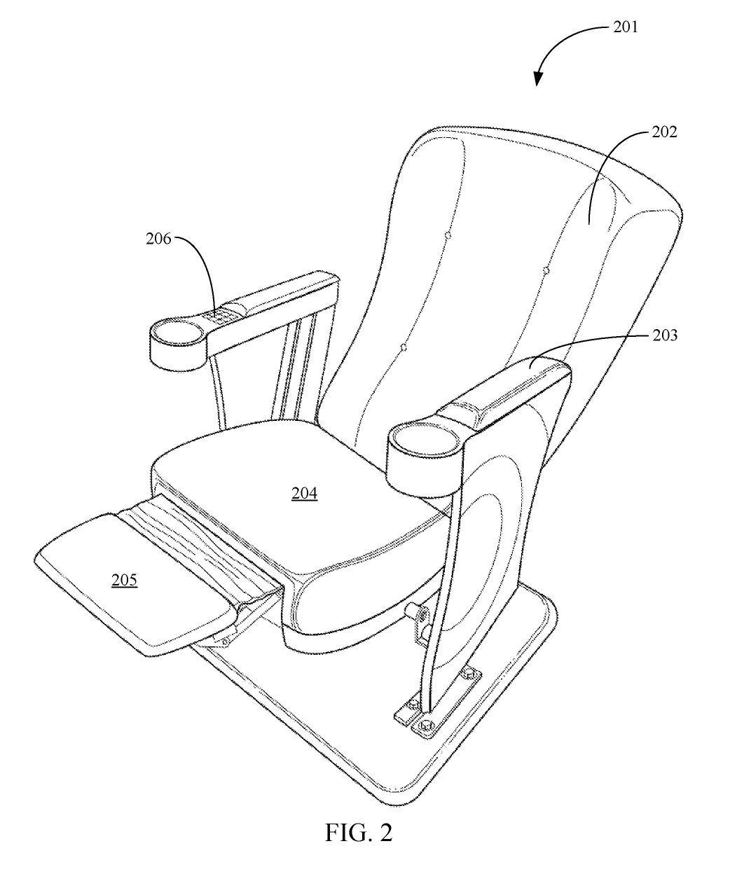

FIG. 2 illustrates a perspective view of a recliner theater seat 201 in an open position. In some embodiments the theater seat comprises a back rest 202, armrest(s) 203, a seat cushion 204, a leg support 205, a user interface 206, and a power supply (not illustrated). FIG. 2 illustrates theater seat 201 in an open position, wherein leg support 205 is raised to support the legs and feet of an individual utilizing seat 201.

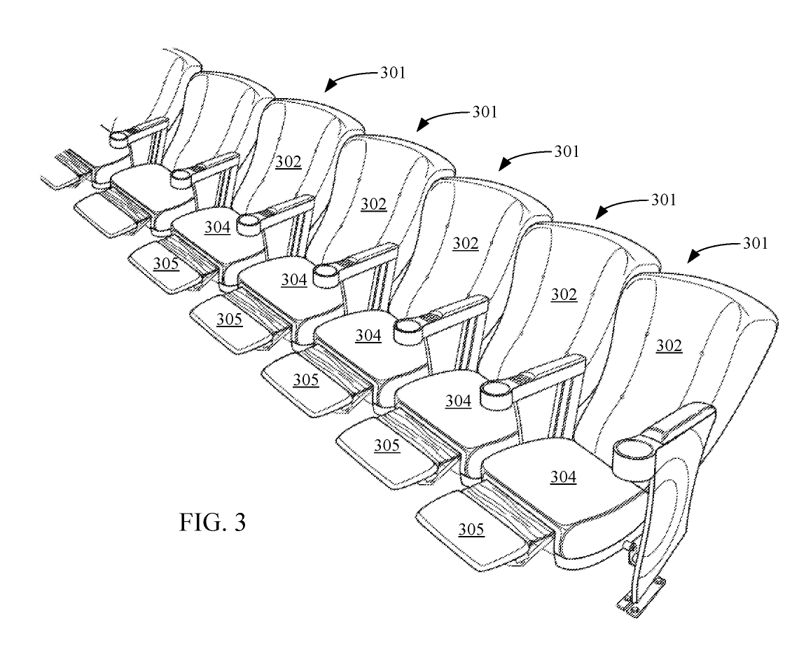

FIG. 3 illustrates a perspective view of several recliner theater seats 301 in an open position. In some embodiments the theater seats 301 may comprise a back rest 302, armrest(s) 303, a seat cushion 304, a leg support 305, a user interface 306, and a power supply (not illustrated). FIG. 3 illustrates theater seats 301 in an open position, wherein the leg supports 305 are raised to support the legs and feet of an individual utilizing seat 301.

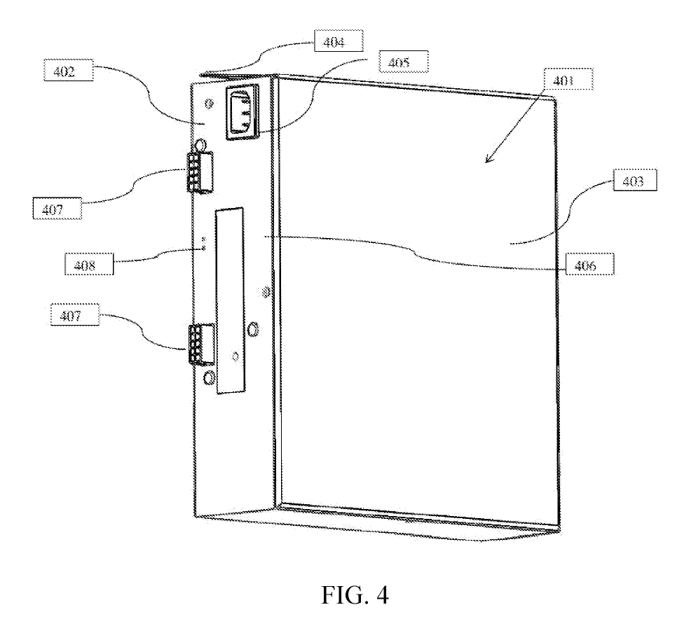

FIG. 4 shows an example of an integrated power supply unit 401 according to some embodiments of the invention. In some embodiments the integrated power supply unit 401 may be used to integrate the functionality of the individual power supply with a battery backup unit in one enclosure. Some embodiments of the integrated power supply unit 401 comprise a chassis 402 and a lid 403 to form an enclosure. In some embodiments heat may be removed from the enclosure with an air vent 404. According to some embodiments AC power is provided through an inlet 405. According to some embodiments when the AC power is present or not present at AC inlet 405; DC power is still available at the DC power outlet(s) 407. According to some embodiments, over power protection to the DC outlet(s) 407 is provided by a power protector 406, for which its internal functionality is shown on an indicator light 408.

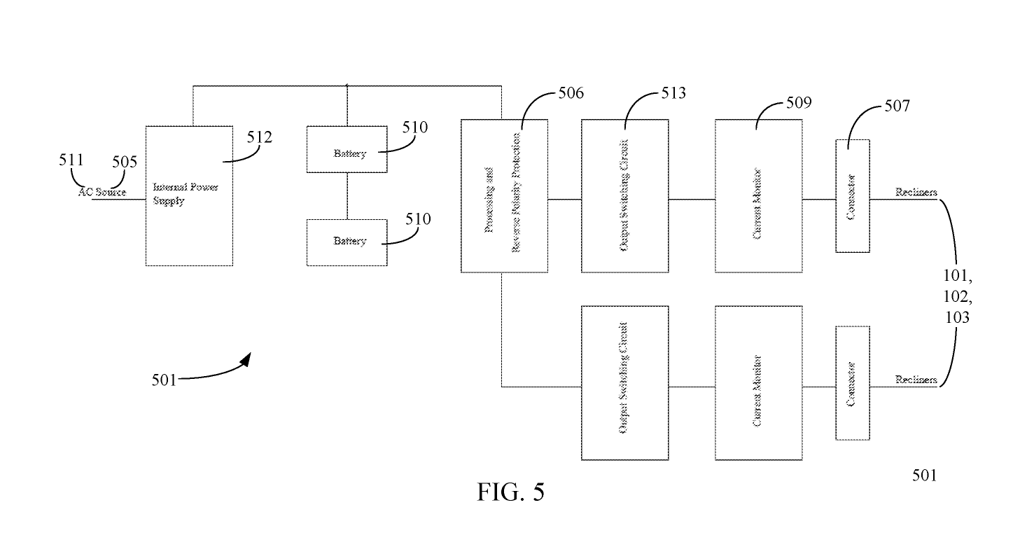

FIG. 5 illustrates a block diagram schematic of an integrated power supply unit 501 according to some embodiments of the invention. In some embodiments integrated power supply unit 501 may be used to integrate the functionality of the individual power supply with battery back-up unit in one enclosure. Some embodiments of integrated power supply unit 501 comprise an enclosure (not shown in FIG. 5, previously illustrated in FIG. 4). According to some embodiments AC power 511 is provided through inlet 405 (not illustrated in FIG. 5, previously illustrated in FIG. 4) to an internal power supply system 512. According to some embodiments when AC power 511 is present or not present on AC inlet 405 (not illustrated in FIG. 5, previously illustrated in FIG. 4) from AC power supply 511; DC power is still available at DC power outlet(s) 407 or connector(s) 507. According to some embodiments, over power protection to DC outlet(s) 507 is provided by a power protector 506. In some embodiments power protector 506 may comprise processing, reverse polarity protection, and overpower protection. In some embodiments AC power 511 flows into an AC/DC power supply/internal power supply unit 512. In some embodiments batteries 510 and output through connectors 507 of the power supply are run in parallel, allowing the integrated power supply unit to allow out as much power as is being supplied, and allowing for batteries 510 to provide the power output to the processing and polarity protection 506, switching circuit 513, current monitor, 509, out to the recliners (not illustrated in FIG. 5, previously illustrated in FIGS. 1-3) via connectors 507.

Embodiments of a method utilized to provide an integrated power supply with battery back-up to electric powered reclining theater seats in accord with some embodiments of the invention are provided herein. In some embodiments the method comprises providing an integrated power supply unit 501. In some embodiments integrated power supply unit 501 may be used to integrate the functionality of the individual power supply with battery backup unit into one enclosure. According to some embodiments AC power 511 is provided through the inlet to an internal power supply system 512. According to some embodiments when the AC power 511 is present or not present on the AC inlet 405 from the AC power supply 511; DC power is still available at the DC power outlet(s) or connector(s) 507. According to some embodiments, over power protection to the DC outlet(s) 507 is provided by power protector 506. In some embodiments the power protector may comprise processing, reverse polarity protection, and overpower protection. In some embodiments AC power 511 flows into the AC/DC power supply/internal power supply unit 512. In some embodiments batteries 510 and output 507 of the power supply are run in parallel, allowing the integrated power supply unit to allow out as much power as is being supplied, and allowing for the batteries 510 to provide the power output to the processing and polarity protection 506, switching circuit 513, current monitor 509, and out to the reclining theater seats via connector 507.

The foregoing examples are merely examples of potential areas of applicability of certain embodiments of the invention, and other areas of applicability will be understood by way of practicing the embodiments of the invention.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description.

What is claimed:

1. A system for providing power to a plurality of theater seat comprising:
a source of A/C power;
an integrated system for providing power to theater seats comprising:
an internal power source;
a battery;
a processing and reverse polarity protection unit;
an output switching circuit;
a current monitor; and
an outlet for providing DC power from the system to at least one theater seat.

2. The system of claim 1, wherein the integrated system for providing power comprises more than one outlet for providing DC power from the system to allow the system to provide power to more than one theater seat.

3. The system of claim 3, wherein the number of theater seats powered by a single integrated power system is selected from a list comprising: 1, 2, 3, 4, 5, 6, 7, 8, 9, 10, 11, 12, 13, 14, 15, 20, 25 seats.

4. The system of claim 1, wherein power is provided to the seats when AC power is present.

5. The system of claim 4, wherein power is provided to the seats when AC power is not present, allowing the leg support portion of theater seat to be lowered to a closed position in the absence of AC power, allowing a user to exit from a fully reclined seat when AC power is lost.
